(19) United States
(12) Patent Application Publication
(10) Pub. No.: US 2025/0368294 A1
(43) Pub. Date: Dec. 4, 2025

(54) MICROMOBILITY VEHICLE WITH CUSTOMIZED STEERING SYSTEM

(71) Applicant: American Honda Motor Co., Inc., Torrance, CA (US)

(72) Inventors: JAMIE DAVIES, HUNTINGTON BEACH, CA (US); DEVON J FUJIOKA, Los Angeles, CA (US)

(21) Appl. No.: 18/678,991

(22) Filed: May 30, 2024

(51) Int. Cl. B62M 6/50; B62J 9/00; B62K 11/00; B62K 21/12

(52) U.S. Cl. CPC B62M 6/50; B62J 9/00; B62K 11/00; B62K 21/12

(57) ABSTRACT

A vehicle is provided. The vehicle includes a wheel configuration having a front wheel assembly and a rear wheel assembly. The vehicle further includes a frame that is coupled to the wheel configuration and a steering system having at least one of a handlebar or a steering wheel mounted at a front portion of the frame. The vehicle further includes a battery unit that is proximal to the front wheel assembly and is disposed on a support portion of the frame. The vehicle further includes a pedal unit that is mounted at a middle portion of the frame. The vehicle further includes a carrier mounted in proximity to the rear wheel assembly and configured to support at least one cargo container.

### BACKGROUND

A cargo vehicle for last mile delivery is typically designed to transport goods from a transportation hub to the final delivery destination. The last mile delivery is an important aspect of the supply chain, especially in urban areas where the demand for quick and efficient delivery services is high. Conventional vehicles used for last mile delivery often face several challenges. One of the main pain points is the steering mechanism. Traditional steering systems in larger vehicles can be less responsive and harder to maneuver, especially in tight city streets. This can lead to difficulties in navigating through congested areas and can increase the time taken for deliveries. Additionally, these vehicles often have larger turning radii, making it challenging to park or unload goods in areas with limited space. This can be a significant issue in densely populated urban areas where parking spaces are scarce. Therefore, there is a need for a more efficient and maneuverable vehicle design for last mile delivery. This could potentially be addressed through the use of modular vehicles, which can be customized to fit the specific needs of last mile delivery, including improved steering mechanisms for better maneuverability in urban environments.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a vehicle is provided. The vehicle may include a wheel configuration that may include a front wheel assembly and a rear wheel assembly. The vehicle may further include a frame that may be coupled to the wheel configuration. The vehicle may further include a steering system having at least one of a handlebar or a steering wheel and may be mounted at a front portion of the frame. The vehicle may further include a battery unit that is proximal to the front wheel assembly and disposed on a support portion of the frame. The vehicle may further include a pedal unit that may be mounted at a middle portion of the frame and a carrier mounted in proximity to the rear wheel assembly. The carrier may be configured to support at least one cargo container.

According to another embodiment of the disclosure, a vehicle is provided. The vehicle may include a wheel configuration that may include a front wheel assembly and a rear wheel assembly. The vehicle may further include a frame that may be coupled to the wheel configuration. The vehicle may further include a steering system having at least one of a handlebar or a steering wheel and may be mounted at a front portion of the frame. The vehicle may further include a battery unit that is proximal to the front wheel assembly and disposed on a support portion of the frame. The vehicle may further include a pedal unit that may be mounted at a middle portion of the frame. The vehicle may further include a carrier mounted in proximity to the rear wheel assembly. The carrier may be configured to support at least one cargo container. The vehicle may further include an electric motor assembly that may be coupled to the rear wheel assembly and an electronic controller that may be communicatively coupled to the electric motor assembly. In an operational state, the electronic controller may be configured to control actuation of the electric motor assembly to drive the rear wheel assembly.

According to another embodiment of the disclosure, a method of assembling a vehicle is provided. The method may include coupling a wheel configuration with the vehicle. The wheel configuration may include a front wheel assembly and a rear wheel assembly. The method may further include coupling a frame with the wheel configuration and mounting a steering system having at least one of a handlebar or a steering wheel at a front portion of the frame. The method may further include disposing a battery unit on a support portion of the frame such that the battery unit is proximal to the front wheel assembly. The method may further include mounting a pedal unit at a middle portion of the frame and further mounting a carrier in proximity of the rear wheel assembly. The carrier may be configured to support at least one cargo container.

### BRIEF DESCRIPTION OF THE DRAWINGS

FIG. 1 is a diagram that illustrates an exemplary vehicle, in accordance with an embodiment of the disclosure.

FIG. 2A is a scenario diagram that illustrates a bottom view of a wheel configurations of the vehicle of FIG. 1, in accordance with an embodiment of the disclosure.

FIG. 2B is another scenario diagram that illustrates a bottom view of a wheel configurations of the vehicle of FIG. 1, in accordance with an embodiment of the disclosure.

FIG. 2C is yet another scenario diagram that illustrates a bottom view of a wheel configurations of the vehicle of FIG. 1, in accordance with an embodiment of the disclosure.

FIG. 2D is yet another scenario diagram that illustrates a bottom view of a wheel configurations of the vehicle of FIG. 1, in accordance with an embodiment of the disclosure.

FIG. 3A is a scenario diagram that illustrates a handlebar of the vehicle of FIG. 1, in accordance with an embodiment of the disclosure.

FIG. 3B is a scenario diagram that illustrates a steering wheel of the vehicle of FIG. 1, in accordance with an embodiment of the disclosure.

FIG. 4 is an exemplary diagram that illustrates a battery unit of the vehicle of FIG. 1, in accordance with an embodiment of the disclosure.

FIG. 5 is a flowchart that illustrates an exemplary method of assembling the vehicle of FIG. 1, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a vehicle. The disclosed vehicle may include a wheel configuration that may include a front wheel assembly and a rear wheel assembly. The disclosed vehicle may further include a frame that may be coupled to the wheel configuration. The disclosed vehicle may further include a steering system that may be mounted at a front portion of the frame. Further, the steering system may include at least one of a handlebar or a steering wheel. The disclosed vehicle may further include a battery unit that is proximal to the front wheel assembly and may be disposed on a support portion of the frame. The disclosed vehicle may further include a pedal unit that may be mounted at a middle portion of the frame. The disclosed vehicle may further include a carrier mounted in proximity to the rear wheel assembly. Further, the carrier may be configured to support at least one cargo container.

Traditionally, developing a micromobility vehicle has a number of constraints. For example, a micromobility vehicle must be structurally fixed with a specific steering mechanism, necessitating multiple structural layouts of the vehicle to accommodate multiple steering mechanisms. However, developing multiple structural layouts for micromobility vehicles in order to install multiple steering mechanisms makes them expensive. Furthermore, developing multiple structural layouts of micromobility vehicles based on different wheel configurations makes them more expensive. Furthermore, micromobility vehicles do not provide pedal assistance to riders or users.

To overcome some of the abovementioned issues, the vehicle may include a frame that may be disposed with a steering system having at least one of a handlebar or a steering wheel. The handlebar or the steering wheel may be altered based on wheel configurations, which reduces the cost of developing plurality of structural layouts. The vehicle may further include an electric motor assembly that may drive rear wheel assembly of the vehicle, which assist the rider or user in paddling the vehicle.

Reference will now be made in detail to specific aspects or features, examples of which are illustrated in the accompanying drawings. Wherever possible, corresponding, or similar reference numbers will be used throughout the drawings to refer to the same or corresponding parts.

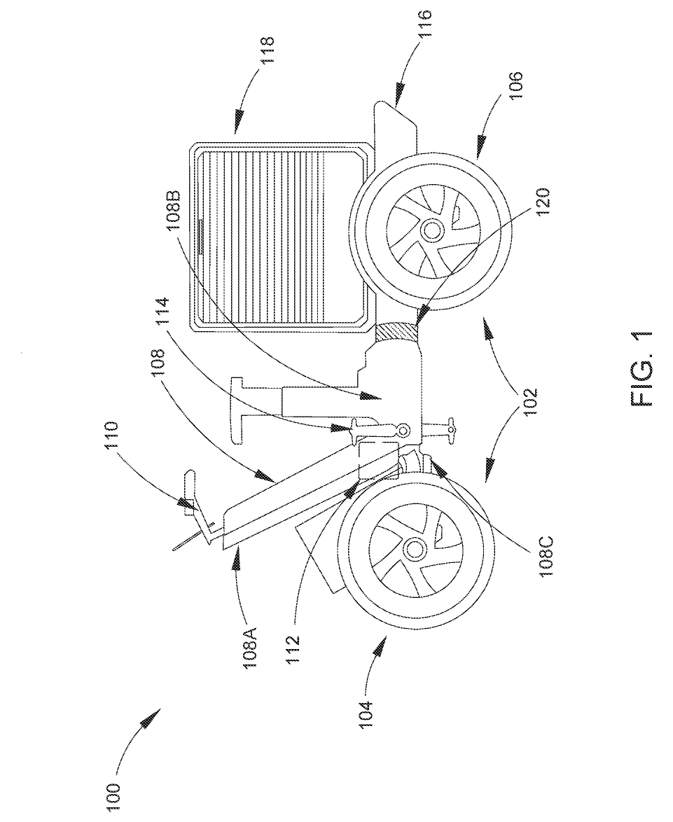

FIG. 1 is a diagram that illustrates an exemplary vehicle, in accordance with an embodiment of the disclosure. With reference to the FIG. 1, there is shown a diagram of a vehicle 100. The vehicle 100 may include a wheel configuration 102, a front wheel assembly 104, and a rear wheel assembly 106. The vehicle 100 may further include a frame 108 having a front portion 108A, a middle portion 108B, and a support portion 108C. The vehicle 100 may further include a steering system 110, a battery unit 112 (i.e., a see-through view of the battery unit 112), a pedal unit 114, a carrier 116, a cargo container 118, and an electric motor assembly 120.

The vehicle 100 with at least two wheels may be a means of transport, which may be operated by a rider at speeds (for example, speed range of 15 km/h to 25 km/h) that may be suitable for micro-mobility or last mile delivery. The vehicle 100 may be categorized as a micromobility vehicle based on a speed of the vehicle 100, a cargo carrying capability, or a mileage of the vehicle 100. Examples of the vehicle 100 may include, but are not limited to, a bicycle, an e-bike, an electric scooter, or an electric pedal assisted bicycle. Such vehicles may be human-powered, or battery powered. The vehicle 100 in FIG. 1 is an electric pedal assisted vehicle, which is merely an example that should not be construed as limiting the disclosure. The present disclosure may be applicable to other types of vehicles (for example, a tricycles, quadracycles, foldable bikes, and the like). The description of such types of the vehicle 100 has been omitted from the disclosure for the sake of brevity.

The wheel configuration 102 may be an arrangement of wheels of the vehicle 100 and may include the front wheel assembly 104 and the rear wheel assembly 106. The wheel configuration 102 may be an assembly of the wheels across the frame 108 of the vehicle 100 based on a type of the vehicle 100 and a connection or position of the wheels across the frame 108.

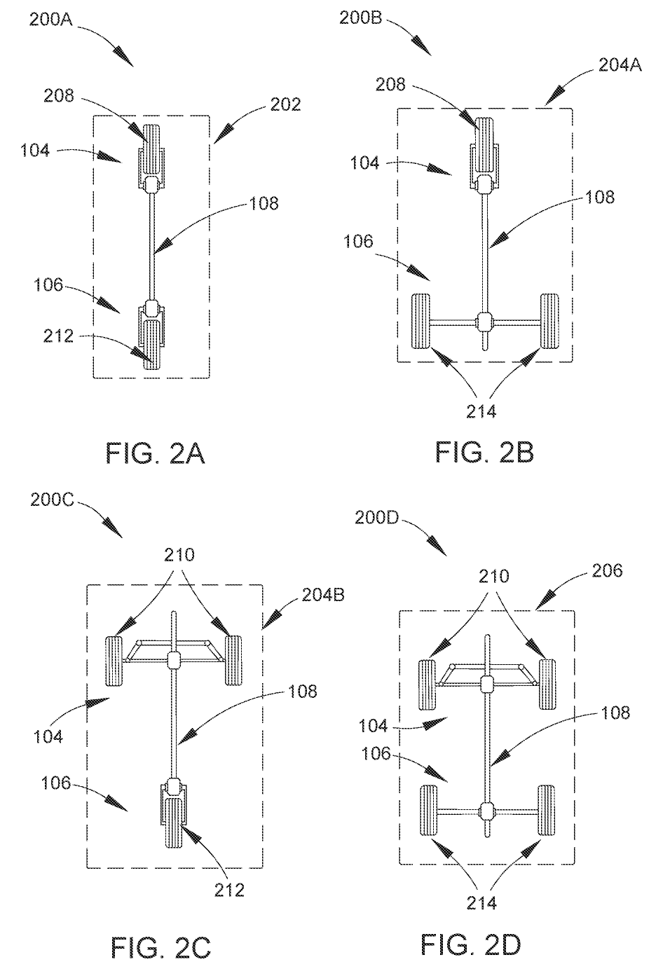

In accordance with an embodiment, the wheel configuration 102 may provide a plurality of layouts for the vehicle 100 that may be adopted based on a number of wheels in the wheel configuration 102. For example, the wheel configuration 102 may correspond to one of a two-wheel configuration, a three-wheel configuration, or a four-wheel configuration, as described, in detail, for example, in FIG. 2A, FIG. 2B, FIG. 2C, and FIG. 2D.

The front wheel assembly 104 may provide at least a forward or reverse movement to the vehicle 100 using at least one a front wheel or a pair of front wheels, as described, in detail, for example in FIG. 2A, FIG. 2B, FIG. 2C, and FIG. 2D. The front wheel assembly 104 may be coupled at a front portion 108A of the frame 108. As an example, the front wheel assembly 104 may receive a propulsion force in at least a forward or reverse direction from pedals of the vehicle 100. As another example, the front wheel assembly 104 may receive a propulsion force in at least a forward or reverse direction from a powertrain system of the vehicle 100 to move the vehicle 100 in at least a forward or reverse direction.

The rear wheel assembly 106 may provide at least a forward or reverse movement to the vehicle 100 using at least one a rear wheel or a pair of rear wheels, as described, in detail, for example in FIG. 2A, FIG. 2B, FIG. 2C, and FIG. 2D. The rear wheel assembly 106 may be coupled at a rear portion (not shown) of the frame 108. As an example, the rear wheel assembly 106 may receive a propulsion force in at least a forward or reverse direction from pedals of the vehicle 100. As another example, the rear wheel assembly 106 may receive a propulsion force in at least a forward or reverse direction from a powertrain system of the vehicle 100 to move the vehicle 100 in at least a forward or reverse direction.

The frame 108 of the vehicle 100 may be a main support structure of the vehicle 100 which may be configured to bear stresses induced on the vehicle 100. Additionally, the frame 108 may be a load-bearing framework of the vehicle 100, which may structurally support a plurality of vehicle systems, such as, but not limited to, a transmission system, a brake system, a suspension system, at least one seat, or a steering system. For example, the frame 108 for a two-wheeler may include a plurality of components, such as, but not limited, suspensions, wheels, a fuel tank, a battery, at least one seat, or a handlebar. As another example, the frame 108 for a three-wheeler or a four-wheeler may include components, such as suspensions, wheels, a fuel tank, a battery, at least one seat, a cabin, at least one of a handlebar or a steering wheel. The present disclosure may be applicable to the frame 108 of other types of vehicle (for example, an electric scooter, an electric skateboard, a shared bicycle, and the like). The description of the frame 108 of such types of the vehicles has been omitted from the disclosure for the sake of brevity.

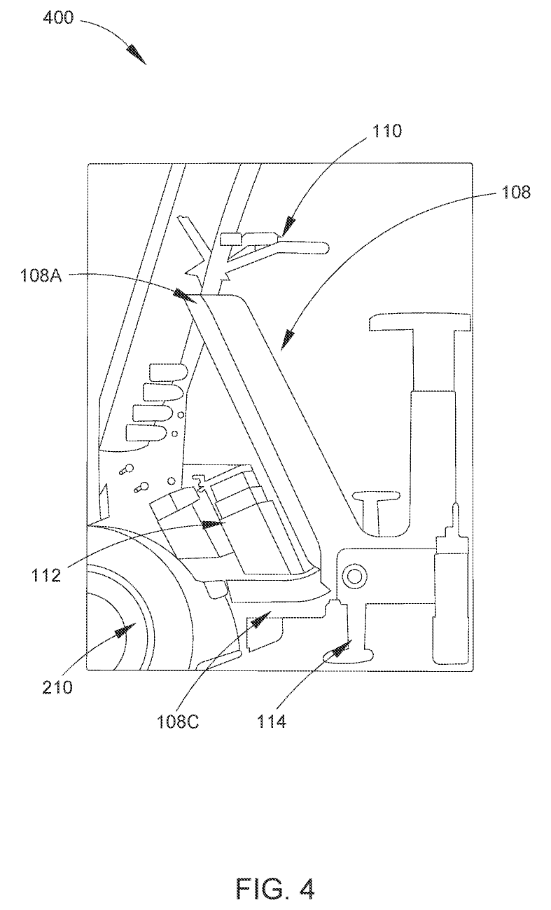

The frame 108 may include the front portion 108A which may substantially face towards a direction of movement of the vehicle 100. For example, the front portion 108A may be at an angle with a horizontal plane. A cross section of the front portion 108A of the frame 108 may have a substantially rectangular shape. Alternatively, the cross section of the front portion 108A of the frame 108 may be formed to have another shape (for example, a substantially square shape, a substantially circular shape, a substantially semi-circular shape, and the like), without a departure from the scope of the present disclosure. The frame 108 may further include the middle portion 108B that may be located between the front portion 108A of the frame and a rear portion (not shown in FIG. 1) of the frame 108. The middle portion 108B may be at an angle with the front portion 108A. Additionally, the middle portion 108B may be inverted “T” shape, as shown, for example, in FIG. 1. A cross section of the middle portion 108B of the frame 108 may have a substantially circular shape. Alternatively, the cross section of middle portion 108B of the frame 108 may be formed to have another shape (for example, a substantially square shape, a substantially rectangular shape, a substantially semi-circular shape, and the like), without a departure from the scope of the present disclosure. The frame 108 may further include the support portion 108C that may be located in proximity of the front portion 108A of the frame 108. The support portion 108C may be an extension that may extend substantially horizontally from the front portion 108A of the frame 108 and towards the middle portion 108B of the frame. The support portion 108C may be configured to support the battery unit 112 of the vehicle 100, as described in detail, for example, in FIG. 4.

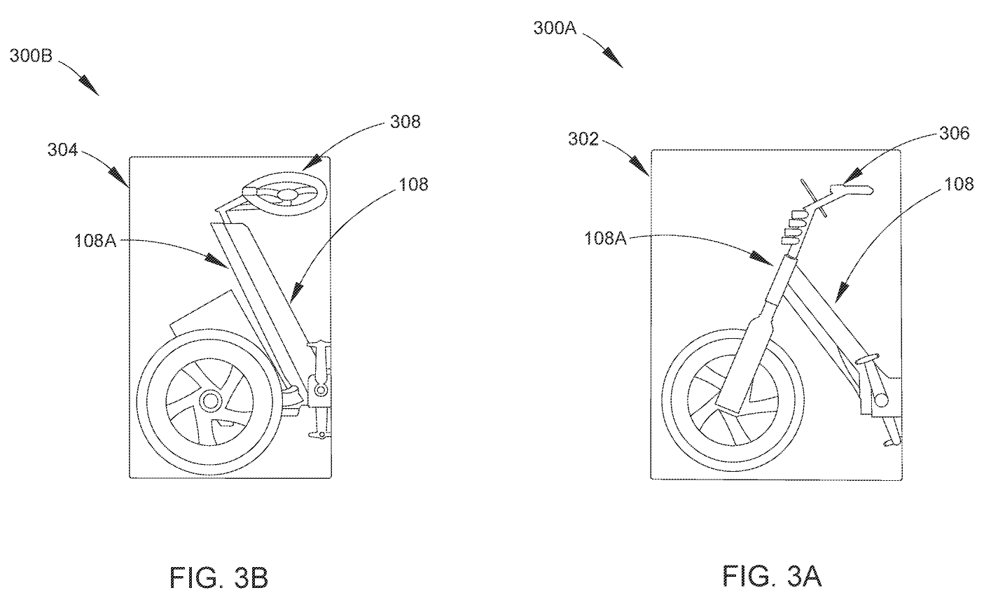

The steering system 110 may control a direction of movement of the vehicle 100 and may include a plurality of components. The steering system 110 may be mounted at the front portion 108A of the frame 108. The steering system 110 may include at least one of a handlebar (for example, a handlebar 306 as shown in FIG. 3A) or a steering wheel (for example, a steering wheel 308 as shown in FIG. 3B). The steering system 110 may further include an electric motor (provided for a power-assisted steering) that may be used by a rider to control movement of the vehicle 100 in a manual mode or a semi-autonomous mode (or an assistive mode). In accordance with an embodiment, the movement or steering of the vehicle 100 may be automatically controlled when the vehicle 100 is in an autonomous or assistive mode. Examples of the steering system 110 may include, but are not limited to, an autonomous steering control, a power-assisted steering system, a vacuum/hydraulic-based steering system, an electro-hydraulic power-assisted system (EHPAS), or a “steer-by-wire” system. In an example embodiment, the steering system 110 for a two-wheeler may include a handlebar (shown in FIG. 3A) and the steering system 110 for a three-wheeled or four-wheeled vehicle may include a steering wheel (shown in FIG. 3B).

The battery unit 112 (i.e., a see-though view as shown in FIG. 1) may be a rechargeable battery unit that acts as a source of electric power for one or more electric circuits or loads (not shown) associated with the vehicle 100. For example, the battery unit 112 may be a source of electrical power for an electronic control unit, a sensor system, an electric powertrain system associated with the vehicle 100, or an electric motor of the vehicle 100. In some embodiments, the battery unit 112 may correspond to a battery pack, which may have a plurality of clusters of batteries, surrounded by a suitable coolant and a charge controller (not shown). Examples of the battery unit 112 may include, but are not limited to, a lead acid battery, a nickel cadmium battery, a nickel–metal hydride battery, a lithium-ion battery, and other rechargeable batteries. The battery unit 112 may be proximal to the front wheel assembly 104 and may be disposed on the support portion 108C of the frame 108. Further details regarding proximal to the front wheel assembly 104, is described, in detail, for example, in FIG. 4.

The pedal unit 114 may be a portion of the vehicle 100 that a rider pushes with their foot to move the vehicle 100 in a forward direction. The pedal unit 114 may be mounted at the middle portion 108B of the frame and may function as a link between the rider's foot or shoe and a crank, enabling legs of the rider to rotate a bottom bracket spindle to move wheels of the vehicle 100 in the forward direction. Typical components of the pedal unit 114 may include a spindle that threads into the crank's end and a body that may be attached with a footrest. The footrest may rotate freely on bearings with respect to the spindle. For example, the pedal unit 114 may be fastened directly to a driven wheel of the front wheel assembly 104 of the vehicle 100 using cranks. As another example, the pedal unit 114 may be fastened directly to a driven wheel of the rear wheel assembly 106 of the vehicle 100 using cranks.

The carrier 116 may be a vehicle structure that may be coupled to a rear portion (not shown) of the vehicle 100. As shown, for example, the carrier 116 is mounted in proximity to the rear wheel assembly 106 of the vehicle 100. The carrier 116 may be mounted at the rear portion (not shown) of the frame 108. As an example, the carrier 116 may be supported by the rear wheel assembly 106 and may be used to transport a variety of items. As another example, the carrier 116 may be a flatbed or container on wheels that may be used to transport items (such as goods, equipment, or heavy cargo) from one destination to another. The carrier 116 may be of several types (for example, a boom, a wheel lift, a self-loader, a quick pick, a flatbed, or a lift flatbed), usually based on a type or a size of the vehicle 100. The carrier 116 may be configured to support the at least one cargo container 118.

The cargo container 118 may be a strong strength container configured for handling, storage, and transportation of cargo items. The cargo container 118 may be a compact reusable steel box that can be used for intermodal shipments of the cargo items. Examples of the cargo container 118 may include, but are not limited to, a corrugated box, an open top container, a double door container, a refrigerated container, or an insulated container.

The electric motor assembly 120 may include suitable logic, circuitry, interfaces, and/or code and may be coupled to the rear wheel assembly 106. The electric motor assembly 120 may be configured to drive the rear wheel assembly 106. The vehicle 100 may further include an electronic controller (not shown in FIG. 1) that may be communicatively coupled to the electric motor assembly 120. The electronic controller may be a specialized electronic circuitry that may control distinct functions, such as, but not limited to, controlling actuation of the electric motor assembly 120 to drive the rear wheel assembly 106. In an embodiment, the electronic controller may be a microprocessor which may receive one or more control commands from the rider to control actuation of the electric motor assembly 120. By way of example, and not limitation, the electronic controller may receive one or more commands from an automotive dashboard, an embedded device, a smartphone, a human-machine interface (HMI), a computer workstation, a handheld computer, a cellular/mobile phone, a portable consumer electronic (CE) device, a server, and other computing devices to control actuation of the electric motor assembly 120 to drive the rear wheel assembly 106.

The electronic controller, in an operational state, may be configured to control actuation of the electric motor assembly 120 to drive the rear wheel assembly 106. In some embodiments, the electronic controller may detect a revolution of the pedals included in the pedal unit 114 using a cadence sensor (included in the pedal unit 114). Based on the detection of the revolution of the pedals, the electronic controller may be configured to control the actuation of the electric motor assembly 120. Additionally, or alternatively, the rider of the vehicle 100 may select a level of pedal assistance. Based on the detection of the revolution of the pedals and the selected level of pedal assistance, the electronic controller may control the actuation of the electric motor assembly 120. For example, if the cadence sensor detect a slow revolution of the pedals (60-70 rpm) and the rider selects an elevated level of pedal assistance, then the electronic controller may control the actuation of the electric motor assembly 120 to drive the rear wheel assembly 106 at a higher speed (i.e., higher than 60-70 rpm). The rear wheel assembly 106 driving at the higher speed amplifies the pedal power of the pedals making it easier for the rider to move the vehicle 100 in the forward direction. As another example, if the cadence sensor detects a fast revolution of the pedals (100-110 rpm) and the rider selects a low level of pedal assistance, then the electronic controller may control the actuation of the electric motor assembly 120 to drive the rear wheel assembly 106 at a lower speed (i.e., lower than 100-110 rpm). The rear wheel assembly 106 driving at the lower speed reduces the pedal power of the pedals making it tougher for the rider to move the vehicle 100 in the forward direction.

FIG. 2A, is a scenario diagram that illustrates a bottom view of a wheel configurations of the vehicle of FIG. 1, in accordance with an embodiment of the disclosure. FIG. 2A is explained in conjunction with elements from FIG. 1. With reference to the FIG. 2A, there is shown an exemplary diagram that illustrates a bottom view 200A of the wheel configuration 102 of the vehicle 100 that includes a two-wheel configuration 202. The bottom view 200A may include the front wheel assembly 104 having a front wheel 208. The bottom view 200A may further include the rear wheel assembly 106 having a rear wheel 212.

The front wheel assembly 104 may include the front wheel 208 in the two-wheel configuration 202. The rear wheel assembly 106 may include the rear wheel 212 in the two-wheel configuration 202. In bottom view 200A, the two-wheel configuration 202 may include the front wheel 208 in the front wheel assembly 104 and the rear wheel 212 in the rear wheel assembly 106. It should be noted that the diagrams of the bottom view 200A of the wheel configuration 102 as shown in FIG. 2A is for exemplary purposes and should not be construed to limit the scope of the disclosure.

FIG. 2B is another scenario diagram that illustrates a bottom view of a wheel configurations of the vehicle of FIG. 1, in accordance with an embodiment of the disclosure. FIG. 2 is explained in conjunction with elements from FIG. 1 and FIG. 2A. With reference to the FIG. 2B, there is shown an exemplary diagram that illustrates a bottom view 200B of the wheel configuration 102 of the vehicle 100 that includes a first three-wheel configuration 204A. The bottom view 200B of the wheel configuration 102 may include the front wheel assembly 104 having a front wheel 208. The bottom view 200B of the wheel configuration 102 may further include the rear wheel assembly 106 having a pair of rear wheels 214.

The front wheel assembly 104 may include the front wheel 208 in the first three-wheel configuration 204A. The rear wheel assembly 106 may include the pair of rear wheels 214 in the first three-wheel configuration 204A. In bottom view 200B, the first three-wheel configuration 204A may include the front wheel 208 in the front wheel assembly 104 and the pair of rear wheels 214 in the rear wheel assembly 106. It should be noted that the diagrams of the bottom view 200B of the wheel configuration 102 as shown in FIG. 2B is for exemplary purposes and should not be construed to limit the scope of the disclosure.

FIG. 2C is yet another scenario diagram that illustrates a bottom view of a wheel configurations of the vehicle of FIG. 1, in accordance with an embodiment of the disclosure. FIG. 2C is explained in conjunction with elements from FIG. 1, FIG. 2A, and FIG. 2B. With reference to the FIG. 2C, there is shown exemplary diagram that illustrates a bottom view 200C of the wheel configuration 102 of the vehicle 100 that includes a second three-wheel configuration 204B. The bottom view 200C of the wheel configuration 102 may include the front wheel assembly 104 having a pair of front wheels 210. The bottom view 200C of the wheel configuration 102 may further include the rear wheel assembly 106 having a rear wheel 212.

The front wheel assembly 104 may include the pair of front wheels 210 in the second three-wheel configuration 204B. The rear wheel assembly 106 may include the rear wheel 212 in the second three-wheel configuration 204B. In bottom view 200C, the second three-wheel configuration 204B may include the pair of front wheels 210 in the front wheel assembly 104 and the rear wheel 212 in the rear wheel assembly 106. It should be noted that the diagrams of the bottom view 200C of the wheel configuration 102 as shown in FIG. 2C is for exemplary purposes and should not be construed to limit the scope of the disclosure.

FIG. 2D is yet another scenario diagram that illustrates a bottom view of a wheel configurations of the vehicle of FIG. 1, in accordance with an embodiment of the disclosure. FIG. 2D is explained in conjunction with elements from FIG. 1, FIG. 2A, FIG. 2B, and FIG. 2C. With reference to the FIG. 2D, there is shown exemplary diagram that illustrates a bottom view 200D of the wheel configuration 102 of the vehicle 100 that includes a four-wheel configuration 206. The bottom view 200D of the wheel configuration 102 may include the front wheel assembly 104 having a pair of front wheels 210. The bottom view 200D of the wheel configuration 102 may further include the rear wheel assembly 106 having a pair of rear wheels 214.

The front wheel assembly 104 may include the pair of front wheels 210 in the four-wheel configuration 206. The rear wheel assembly 106 may include the pair of rear wheels 214 in the four-wheel configuration 206. In bottom view 200D, the four-wheel configuration 206 may include the pair of front wheels 210 in the front wheel assembly 104 and the pair of rear wheels 214 in the rear wheel assembly 106. It should be noted that the diagrams of the bottom view 200D of the wheel configuration 102 as shown in FIG. 2D is for exemplary purposes and should not be construed to limit the scope of the disclosure.

FIG. 3A is a scenario diagram that illustrates a handlebar of the vehicle of FIG. 1, in accordance with an embodiment of the disclosure. FIG. 3A is explained in conjunction with elements from FIG. 1, FIG. 2A, FIG. 2B, FIG. 2C, and FIG. 2D. With reference to the FIG. 3A, there is shown a scenario diagram 300A that includes a first scenario 302 having a handlebar 306 mounted at the front portion 108A of the frame 108.

The vehicle 100 may include the frame 108 having the front portion 108A. The front portion 108A of the frame 108 may include the steering system 110 (as shown in FIG. 1) mounted at the front portion 108A of the frame 108, as described in detail, for example, in FIG. 1. The steering system 110 (as shown in FIG. 1) may include the handlebar 306. The vehicle 100 may include the wheel configuration 102 having the two-wheel configuration 202, as described, for example, in FIG. 2A.

In the first scenario 302, the vehicle 100 may include the handlebar 306 when the wheel configuration 102 is the two-wheel configuration 202. The handlebar 306 may be a straight or bent bar with a handle at each end which may be used to steer the vehicle 100. The handlebar 306 may provide a mounting place for controls such as brake, throttle, clutch, and rear-view mirrors to support a rider. The handlebar 306 in FIG. 3A is a yolk handlebar, which is merely an example that should not be construed as limiting the disclosure. The present disclosure may be applicable to other types of handlebars (for example, flat handlebars, cruiser handlebars, riser handlebars, drop handlebars and the like). The description of such types of handlebars has been omitted from the disclosure for the sake of brevity.

It should be noted that the scenario diagram 300A of FIG. 3A is for exemplary purposes and should not be construed to limit the scope of the disclosure.

FIG. 3B is a scenario diagram that illustrates a steering wheel of the vehicle of FIG. 1, in accordance with an embodiment of the disclosure. FIG. 3B is explained in conjunction with elements from FIG. 1, FIG. 2A, FIG. 2B, FIG. 2C, FIG. 2D, and FIG. 3A. With reference to the FIG. 3B, there is shown a scenario diagram 300B that further includes a second scenario 304 having a steering wheel 308 mounted at the front portion 108A of the frame 108.

The vehicle 100 may include the frame 108 having the front portion 108A. The front portion 108A of the frame 108 may include the steering system 110 (as shown in FIG. 1) mounted at the front portion 108A of the frame 108, as described in detail, for example, in FIG. 1. The steering system 110 (as shown in FIG. 1) may include the steering wheel 308. The vehicle 100 may include the wheel configuration 102 having the first three-wheel configuration 204A, the second three-wheel configuration 204B, and the four-wheel configuration 206, as described in detail, for example, in FIG. 2B and FIG. 2C.

In the second scenario 304, the vehicle 100 may include the steering wheel 308 when the wheel configuration 102 is the first three-wheel configuration 204A, the second three-wheel configuration 204B, or the four-wheel configuration 206. The steering wheel 308 may have a steering mechanism and a wheel which may be used to steer the vehicle 100. The steering wheel 308 may provide a mounting place for controls such as brake, throttle, clutch, and rear-view mirrors to support the rider.

It should be noted that the scenario diagram 300B of FIG. 3B is for exemplary purposes and should not be construed to limit the scope of the disclosure.

FIG. 4 is an exemplary diagram that illustrates a battery unit of the vehicle of FIG. 1, in accordance with an embodiment of the disclosure. FIG. 4 is explained in conjunction with elements from FIG. 1, FIG. 2A, FIG. 2B, FIG. 2C, FIG. 2D, FIG. 3A, and FIG. 3B. With reference to the FIG. 4, there is shown an exemplary diagram 400 that illustrates the vehicle 100 (as shown in FIG. 1) having the battery unit 112. The battery unit 112 may be proximal to the front wheel assembly 104 and disposed on the support portion 108C of the frame 108. In accordance with an embodiment, the battery unit 112 may be disposed on a portion of the frame 108 that is between the front portion 108A and the middle portion 108B. Alternatively, the battery unit 112 may be disposed on a portion of the frame 108 that horizontally extends from the middle portion 108B towards the pedal unit 114. The support portion 108C may be an extension that extend substantially horizontally from the front portion 108A and towards the middle portion 108B of the frame 108, as described, in detail, for example, in FIG. 1. Alternatively, the battery unit 112 may be disposed on the front wheel assembly 104.

The vehicle 100 may include the front wheel assembly 104 that has the pair of front wheels 210 (as shown in FIG. 2). The battery unit 112 may be disposed between the pair of front wheel 208. It should be noted that the battery unit 112 disposed between the pair of front wheels 210, as shown in FIG. 4, is for exemplary purposes and should not be construed to limit the scope of the disclosure.

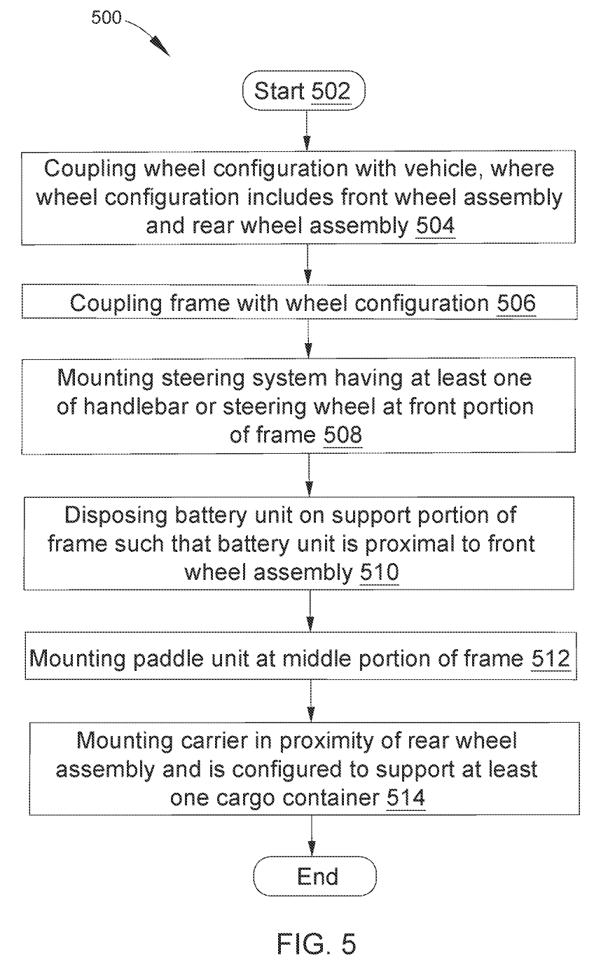

FIG. 5 is a flowchart that illustrates an exemplary method of assembling the vehicle of FIG. 1, in accordance with an embodiment of the disclosure. FIG. 5 is explained in conjunction with elements from FIG. 1, FIG. 2A, FIG. 2B, FIG. 2C, FIG. 2D, FIG. 3A, FIG. 3B, and FIG. 4. With reference to FIG. 5, there is shown a flowchart 500, which may depict a method of assembling the vehicle 100. The method illustrated in the flowchart 500 may start at 502 and proceed to 504.

At 504, the wheel configuration 102 may be coupled with the vehicle 100. The wheel configuration 102 may include the front wheel assembly 104 and the rear wheel assembly 106, as described in detail, for example, in FIG. 1, FIG. 2A, FIG. 2B, FIG. 2C, and FIG. 2D.

At 506, the frame 108 may be coupled with the wheel configuration 102. The frame 108 may include the front portion 108A, the middle portion 108B, and the support portion 108C, as described in detail, for example, in FIG. 1.

At 508, the steering system 110 may be mounted at the front portion 108A of the frame 108. The steering system 110 may include at least one of the handlebar 306 or the steering wheel 308, as described in detail, for example, in FIG. 1, FIG. 3A, and FIG. 3B.

At 510, the battery unit 112 may be disposed on the support portion 108C of the frame 108 such that the battery unit 112 is proximal to the front wheel assembly 104, as described in detail, for example, in FIG. 1, FIG. 2A, FIG. 2B, FIG. 2C, FIG. 2D, and FIG. 4.

At 512, the pedal unit 114 may be mounted at the middle portion 108B of the frame 108, as described in detail, for example, in FIG. 1.

At 514, the carrier 116 may be mounted in proximity to the rear wheel assembly 106. The carrier 116 may be configured to support the at least one cargo container 118, as described in detail, for example, in FIG. 1.

Although the flowchart 500 is illustrated as discrete operations, such as 502, 504, 506, 508, 510, 512, and 514 the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including,” “comprising,” “incorporating,” “consisting of,” “have,” “is” used to describe, and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader’s understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A vehicle, comprising:
a wheel configuration that includes a front wheel assembly and a rear wheel assembly;
a frame coupled to the wheel configuration;
a steering system having at least one of a handlebar or a steering wheel and mounted at a front portion of the frame;
a battery unit that is proximal to the front wheel assembly and disposed on a support portion of the frame;
a pedal unit mounted at a middle portion of the frame; and
a carrier mounted in proximity to the rear wheel assembly and is configured to support at least one cargo container.

2. The vehicle according to claim 1, wherein the wheel configuration corresponds to at least one of a two-wheel configuration, a three-wheel configuration, or a four-wheel configuration.

3. The vehicle according to claim 1, wherein the front wheel assembly includes a front wheel in a two-wheel configuration or a pair of front wheels in a three-wheel configuration or a four-wheel configuration.

4. The vehicle according to claim 3, wherein the battery unit is disposed between the pair of front wheels.

5. The vehicle according to claim 1, wherein the rear wheel assembly includes a rear wheel in a two-wheel configuration or a pair of rear wheels in a three-wheel configuration or a four-wheel configuration.

6. The vehicle according to claim 1, further comprising:
an electric motor assembly coupled to the rear wheel assembly; and
an electronic controller communicatively coupled to the electric motor assembly,
wherein, in an operational state, the electronic controller is configured to control actuation of the electric motor assembly to drive the rear wheel assembly.

7. The vehicle according to claim 6, wherein the electronic controller is further configured to:
detect revolution of pedals included in the pedal unit; and
control the actuation of the electric motor assembly based on the detection.

8. The vehicle according to claim 1, wherein the vehicle includes the handlebar when the wheel configuration is a two-wheel configuration.

9. The vehicle according to claim 1, wherein the vehicle includes the steering wheel when the wheel configuration is a three-wheel configuration or a four-wheel configuration.

10. A vehicle, comprising:
a wheel configuration that includes a front wheel assembly and a rear wheel assembly;
a frame coupled to the wheel configuration;
a steering system having at least one of a handlebar or a steering wheel and mounted at a front portion of the frame;
a battery unit that is proximal to the front wheel assembly and disposed on a support portion of the frame;
a pedal unit mounted at a middle portion of the frame;
a carrier mounted in proximity to the rear wheel assembly and is configured to support at least one cargo container;
an electric motor assembly coupled to the rear wheel assembly; and
an electronic controller communicatively coupled to the electric motor assembly,
wherein, in an operational state, the electronic controller is configured to control actuation of the electric motor assembly to drive the rear wheel assembly.

11. The vehicle according to claim 10, wherein the wheel configuration corresponds to at least one of a two-wheel configuration, a three-wheel configuration, or a four-wheel configuration.

12. The vehicle according to claim 10, wherein the front wheel assembly includes a front wheel in a two-wheel configuration or a pair of front wheels in a three-wheel configuration or a four-wheel configuration.

13. The vehicle according to claim 10, wherein the rear wheel assembly includes a rear wheel in a two-wheel configuration or a pair of rear wheels in a three-wheel configuration or a four-wheel configuration.

14. The vehicle according to claim 10, wherein the electronic controller is further configured to:
detect revolution of pedals included in the pedal unit; and
control the actuation of the electric motor assembly based on the detection.

15. The vehicle according to claim 10, wherein the vehicle includes:
the handlebar when the wheel configuration is a two-wheel configuration; and
the steering wheel when the wheel configuration is a three-wheel configuration or a four-wheel configuration.

16. A method of assembling a vehicle, comprising:
coupling a wheel configuration with the vehicle, wherein the wheel configuration includes a front wheel assembly and a rear wheel assembly;
coupling a frame with the wheel configuration;
mounting a steering system having at least one of a handlebar or a steering wheel at a front portion of the frame;
disposing a battery unit on a support portion of the frame such that the battery unit is proximal to the front wheel assembly;
mounting a pedal unit at a middle portion of the frame; and
mounting a carrier in proximity of the rear wheel assembly and is configured to support at least one cargo container.

17. The method according to claim 16, wherein the wheel configuration corresponds to at least one of a two-wheel configuration, a three-wheel configuration, or a four-wheel configuration.

18. The method according to claim 16, wherein the vehicle includes:
the handlebar when the wheel configuration is a two-wheel configuration; and
the steering wheel when the wheel configuration is a three-wheel configuration or a four-wheel configuration.

19. The method according to claim 16, further comprising:
coupling an electric motor assembly to the rear wheel assembly; and
communicatively coupling an electronic controller to the electric motor assembly; and
controlling, by the electronic controller, actuation of the electric motor assembly to drive the rear wheel assembly in an operational state.

20. The method according to claim 19, further comprising:
detecting, by the electronic controller, revolution of pedals included in the pedal unit; and
controlling, by the electronic controller, the actuation of the electric motor assembly based on the detection.
